(19) United States
(12) Patent Application Publication
(10) Pub. No.: US 2007/0291860 A1
(43) Pub. Date: Dec. 20, 2007

(54) Recursive Sequence Generation For Selected Mapping In Multi-Carrier Systems

(76) Inventors: Haifeng Wang, Shanghai (CN); Bingyang Wu, Nanjing (CN); Ming Chen, Nanjing (CN); Shixin Cheng, Nanjing (CN)

Correspondence Address: HARRINGTON & SMITH, PC, 4 RESEARCH DRIVE, SHELTON, CT, 06484-6212, US

(21) Appl. No.: 11/664,446

(22) PCT Filed: Oct. 28, 2004
(86) PCT No.: PCT/IB04/03533

§ 371 Date: Apr. 2, 2007

(51) Int. Cl. H04L 27/28

(52) U.S. Cl. 375/260; 375/E07.021

(57) ABSTRACT

This invention relates to a method, device, computer program and computer program product for determining a mapping for a sequence of information-carrying values, including determining K representations of a sequence of information-carrying values in K successive stages, respectively, wherein in a first stage, a first representation of said K representations is determined to be equal to said sequence of information-carrying values, wherein in subsequent stages, each representation is determined by performing a mapping operation on the representation determined in the preceding stage, and wherein said mapping operation is the same for each stage; calculating, in each stage, a parameter from a transformation of the representation determined in said stage; and determining for which stage of said K stages an extreme value of said parameter is calculated. The invention further relates to a method, device, computer program and computer program product for inverse-mapping a mapped sequence of information-carrying values, and a system for the transfer of information-carrying values.

### FIELD OF THE INVENTION

This invention relates to a method, device, computer program and computer program product for determining a mapping for a sequence of information-carrying values. The invention further relates to a method, device, computer program and computer program product for inverse-mapping a mapped sequence of information-carrying values, and a system for the transfer of information-carrying values.

### BACKGROUND OF THE INVENTION

Multi-carrier (MC) Modulation (MCM) is an effective transmission scheme for high data rate applications on frequency-selective transmission channels because inter-symbol interference arising from the frequency-selectivity of the transmission channel is effectively combated. MCM thus has been selected as the transmission scheme in several standardization bodies like IEEE 802.11, 802.16 and HIPERMAN. Also future 4G mobile research projects consider MCM as a prime candidate for the transmission scheme.

In MCM, transmit data bits stemming form a data source are first mapped to transmit modulation symbols as prescribed by a phase- and/or amplitude shift keying scheme, such as for instance a Quadrature Amplitude Modulation (QAM) scheme, and each transmit modulation symbol is then modulated onto a respective frequency sub-carrier that consumes a fraction of the overall available transmission bandwidth. The spacing of these sub-carriers is chosen so that the sub-carriers are orthogonal to each other. For this reason, MCM is also often referred to as Orthogonal Frequency Division Multiplex (OFDM). When the sub-carrier bandwidth is smaller than the coherence bandwidth of the transmission channel, the channel impulse response of each sub-carrier is frequency-flat and can be easily equalized.

Modulation of a block of transmit modulation symbols in an MC transmitter is accomplished via an Inverse Fourier Transformation (IFT), which accounts for the fact that the transmit modulation symbols are assigned to respective sub-carriers in the frequency domain and need to be transformed to the time domain to obtain an actual time-domain transmit signal. This time-domain transmit signal then is transmitted via a wire-bound or wire-less transmission channel to a receiver to obtain a time-domain receive signal. The receiver performs a Fourier Transformation (FT) on the receive signal to obtain a frequency-domain block of receive modulation symbols, wherein each receive modulation symbol in this block of receive modulation symbols is associated with one sub-carrier and is obtained from the transmission of a respective transmit modulation symbol over the respective sub-carrier transmission channel and the addition of a sub-carrier-specific noise portion.

When transforming a block of transmit modulation symbols via the IFT, each transmit modulation symbol is modulated onto a sub-carrier with a different center frequency, and subsequently all modulated sub-carriers are added to obtain said time-domain transmit signal. Although the transmit modulation symbols usually stem from a limited modulation symbol alphabet and, correspondingly, also the absolute values of the transmit modulation symbols stem from a limited set of absolute values, the addition of the modulated sub-carriers with different respective center frequencies causes large variance in the absolute values of the values of the time-domain transmit signal at different time instances. A measure for this variance is the Peak-to-Average-Power-Ratio (PAPR) of the transmit signal, which is computed as the power of the maximum value, i.e. the peak, in a transmit signal divided by the average power of all values in the transmit signal. When the number of sub-carriers N is large, the MC transmit signal can be considered as a zero-mean Gaussian random process due to the central limit theorem, and the PAPR can then be shown to be proportional to N. Consequently, in an MC system with increasing number of sub-carriers N, which is usually in the order of 256, 512 or even higher, system linearity over a large dynamic range is needed, and the efficiency of the power amplifiers in the transmitter and receiver is significantly reduced. Insufficient dynamic range of the power amplifiers leads to clipping of the MC transmit and/or receive signals and causes spectral growth of the MC transmit signal in the form of inter-modulation among sub-carriers and out-of-band radiation, which will severely degrade the MC system performance.

Many algorithms have been proposed to reduce the PAPR of MC transmit signals, e.g., Selected Mapping (SLM), Partial Transmitting Sequence (PTS), coding, and digital clipping.

SLM is a relatively simple scheme for practical solutions that achieves a good trade-off between complexity and performance. In an SLM process, K different transmit signal candidates representing the same information are generated, wherein then one of the K transmit signal candidates with the lowest PAPR is selected and transmitted.

How to generate different transmit signal candidates representing the same information is the most important operation in the SLM process. Approaches based on phase rotation, scrambling and interleaving of the transmit data bits (bit-level SLM) or transmit modulation symbols (symbol-level SLM) are known. The obtained representations of said transmit data bits or transmit modulation symbols are then inverse Fourier transformed (after bit-to-symbol mapping in case of bit-level SLM) to obtain the transmit signal candidates. If the different generated transmit signal candidates are statistically independent, SLM approaches the best PAPR reduction performance.

Interleaving-based SLM reorders either the sequence of transmit modulation symbols contained in the block of transmit modulation symbols (symbol-level interleaving), or reorders the sequence of data bits before their mapping to transmit modulation symbols (bit-level interleaving). There is no need for mathematical or logical computation in the interleaving process. However, it requires additional buffer devices and induces a time delay.

Random interleaving reorders the sequence of transmit modulation symbols/data bits in a random order so that the K interleaved sequences of transmit modulation symbols/data bits have the smallest statistical correlation. Random interleaving has the best PAPR reduction performance, but requires a very complex implementation.

In contrast, periodic block interleaving can be simply implemented by writing the sequence of transmit modulation symbols/data bits that are to be interleaved into a matrix column by column and reading it row by row. The periodic block interleaving can effectively reduce the PAPR with only a slight performance degradation compared to random interleaving.

FIG. 1a depicts the basic components of a transmitter-site bit-level SLM instance 1 and a receiver-site SLM instance 2 according to the prior art.

At the transmitter site, a sequence of transmit data bits is fed into said SLM instance 1 as input sequence. In K branches of said SLM instance 1, then K representations of said sequence of transmit data bits are generated, subsequently said representations are bit-to-symbol mapped to obtain respective sequences of transmit modulation symbols in instances 11, and then said sequences of transmit modulation symbols are inverse Fourier transformed via Inverse Fast Fourier Transforms (IFFTs) in respective IFFT instances 12 to obtain transmit signal candidates. In the upper branch of SLM instance 1, said representation of said sequence of transmit data bits is said sequence of transmit data bits itself. In all K−1 other branches, said representation of said sequence of transmit data bits is generated by performing a mapping operation in respective mapping instances 10-1 . . . 10-(K−1) on said sequence of transmit data bits. This mapping operation may for instance be a phase rotation, a scrambling or an interleaving of said transmit data bits in said sequence of transmit data bits. The K transmit signal candidates as output by the IFFT instances 12 of the K branches are then compared with respect to their PAPRs in instance 12, and the transmit signal candidate with the lowest PAPR then can be used as base-band transmit signal. To enable the receiver SLM instance 2 to perform inverse SLM mapping, Side Information (SI) on the index of the branch that achieved said lowest PAPR is added to said transformed representation with said lowest PAPR.

Said base-band transmit signal then is furnished with a cyclic prefix, digital-to-analog converted, amplified, up-converted to a carrier frequency and transmitted via one or several antennas. At a receiver, a corresponding receive signal is received via an antenna, down-converted to base-band, amplified, analog-to-digital converted, and a cyclic prefix is removed to obtain a base-band receive signal. The receiver processing may further comprise synchronization and equalization.

In receiver-site SLM instance 2, when receiving said base-band receive signal, at first said SI is extracted in an instance 23, and then a Fast Fourier Transformation (FFT) and symbol-to-bit mapping is performed on said base-band receive signal in an FFT instance 22 and a symbol-to-bit mapping instance 21. At the output of the symbol-to-bit mapping instance 21, then a sequence of data bits is obtained that corresponds to said representation of said sequence of transmit data bits are the receiver site. To recover said sequence of transmit data bits from said sequence of data bits that is output by symbol-to-bit mapping instance, then an inverse mapping operation that matches the mapping operation that was performed at the transmitter site has to be performed on said sequence of data bits that is output by symbol-to-bit mapping instance. To this end, said receiver-site SLM instance 2 possesses K branches, wherein the lower K−1 branches are equipped with inverse mapping instances 20-1 . . . 20-(K−1) that correspond to the mapping instances 10-1 . . . 10-(K−1) in the lower branches at the transmitter site. As no mapping was performed in the upper branch of transmitter-site SLM instance 1, correspondingly no inverse mapping instance is required in the upper branch of receiver-site SLM instance 2. A switch 24 allows to select between all branches in order to connect the output of the symbol-to-bit mapping instance 21 with the upper (no-action) branch or the inverse mapping instances 20-1 . . . 20-(K−1) in the lower K−1 branches, wherein one of said branches is selected according to said extracted SI, as is indicated by the dashed line between instance 23 and switch 24. At the output of the selected branch, then a sequence of receive data bits is obtained, which represents the desired sequence of transmit data bits, and can be processed by a data sink of the receiver.

FIG. 1b depicts the basic components of a transmitter-site symbol-level SLM instance 1 and a corresponding receiver-site SLM instance 2 according to the prior art. As can be readily seen by comparing FIGS. 1a and 1b, in symbol-level SLM only one bit-to-symbol mapping instance 11 is required at the transmitter site. This bit-to-symbol mapping instance 11 is now located before the mapping instances 10-1 . . . 10-(K−1), so that mapping now takes place with symbols instead of bits.

Correspondingly, for symbol-level SLM to be implemented at the receiver site, symbol-to-bit mapping instance 21 is located after the inverse mapping instances 20-1 . . . 20-(K−1).

As can be seen from FIGS. 1a and 1b, to allow for SLM-based reduction of the PAPR of MC transmit signals, K−1 different mapping instances 10-1 . . . 10-(K−1) are required to be processed at the transmitter, and K−1 different inverse mapping instances 20-1 . . . 20-(K−1) are required to be implemented (but only one branch to be processed) at the receiver, which renders the transmitter and receiver processing rather complex. Furthermore, to allow for a comparison of the K different transmit signal candidates in instance 13, storage space for K transmit signal candidates has to be provided at the transmitter-site SLM instance, which may require an increase in the main memory of a processor that performs the base band signal processing at the transmitter site.

### SUMMARY OF THE INVENTION

In view of the above-mentioned problem, it is, inter alia, an object of the present invention to provide an improved method, computer program, computer program product and a device for selecting a mapping for a sequence of information-carrying values; to provide an improved method, device, computer program and computer program product for inverse-mapping a selected representation of a sequence of information-carrying values, and to provide an improved system for the transfer of information-carrying values.

It is proposed a method for determining a mapping for a sequence of information-carrying values, comprising determining K representations of a sequence of information-carrying values in K successive stages, respectively, wherein in a first stage, a first representation of said K representations is determined to be equal to said sequence of information-carrying values, wherein in subsequent stages, each representation is determined by performing a mapping operation on the representation determined in the preceding stage, and wherein said mapping operation is the same for each stage; calculating, in each stage, a parameter from a transformation of the representation determined in said stage; and determining for which stage of said K stages an extreme value of said parameter is calculated.

Said information-carrying values may for instance be data bits, or modulation symbols that are obtained from data bits by bit-to-symbol mapping as for instance prescribed by a phase- and/or amplitude shift keying scheme.

K representations of said sequence of information-carrying values are successively determined, wherein each of said representations basically contains the same information as said sequence of information-carrying values.

One representation is determined per stage, and, apart from the representation in the first stage, which equals said sequence of information-carrying values, the representation of each stage depends on the representation of the preceding stage, as it is obtained from said representation of the preceding stage via a mapping operation. This mapping operation may for instance be based on phase rotation, scrambling or interleaving of the values of said representations, and is the same for each stage in which it is applied. Due to the successive application of the same mapping operation on the sequence of information-carrying values in each stage, all of said K representations are different from each other, and one respective mapping can be defined for each of said stages with respect to said sequence of information-carrying symbols, wherein said mapping in the first stage is the identity mapping, said mapping in the second stage is defined by said mapping operation, the mapping in the third stage is defined by two times said mapping operation, and so forth.

In each stage, a parameter is calculated from a transformation of the representation determined in said stage. Said transformation may for instance be an inverse Fourier transformation, and said parameter may for instance be a PAPR of said transformed representation.

Finally, it is determined for which stage of said K stages an extreme value of said parameter is calculated. Therein, said extreme value may for instance be a maximum or minimum value of said parameter. The mapping that corresponds to the stage for which said extreme value of said parameter is calculated then may be determined as an optimum mapping for said sequence of information-carrying values.

Thus according to the present invention, K different representations of a sequence of information-carrying symbols can be generated successively based on only one mapping operation, whereas in prior art, K−1 different mapping operations have to be performed on the sequence of information-carrying values in parallel. Thus according to the present invention, the implementation complexity of the process of determining K representations of said sequence of information-carrying symbols is vastly reduced. The successive determination of the K representation also allows for a simplified inverse mapping operation, which can be implemented by only one inverse mapping operation.

According to an embodiment of the method for determining a mapping for a sequence of information-carrying values according to the present invention, said number K equals a pre-defined number of stages. Then a pre-defined number of representations of said sequence of information-carrying values is determined, and the respective parameters of a transformation of said respective representations are calculated and analysed for an extreme value. Said extreme value may then either be determined successively in each stage, or the parameters calculated in each stage may be stored and analysed after the last of said K stages.

According to a further embodiment of the method for determining a mapping for a sequence of information-carrying values according to the present invention, said number K is smaller than or equal to a pre-defined number of stages, wherein said step of determining for which stage an extreme value of said parameter is calculated comprises determining, in each stage, if a value of said parameter calculated in said stage fulfils a condition with respect to a pre-defined threshold value, and wherein, if said condition is fulfilled in a stage, said number K equals the index of said stage in which said condition is first fulfilled, and otherwise equals said pre-defined number of stages.

Thus a maximum number of stages is fixed by said pre-defined number of stages, but the number K of stages does not necessarily reach said maximum number. This is accomplished by integrating a check whether said parameter calculated in each stage fulfils a condition with respect to a pre-defined threshold value, and if this condition is fulfilled, no further stages are processed. Said condition may for instance be that said calculated parameter is smaller or larger than said pre-defined threshold value. Reducing the number of stages significantly reduces the required amount of processing and the processing time. For instance, if said parameter is a PAPR of said transformation of said representation determined in each stage, said pre-defined threshold value may be a pre-defined PAPR threshold value.

A further embodiment of the method for determining a mapping for a sequence of information-carrying values according to the present invention further comprises outputting an index of said stage for which said extreme value of said parameter was calculated, and said transformation of said representation determined in said stage. To this end, said transformation of said representation may have been stored, and then may not have to be determined anew when further processing said sequence of information-carrying values.

According to a further embodiment of the method for determining a mapping for a sequence of information-carrying values according to the present invention, said transformation of said representation determined in said stage for which said extreme value of said parameter was calculated represents a transmit signal in a communication system, and wherein information on said index of said stage for which said extreme value of said parameter was calculated is included into said transmit signal prior to transmission. Said information on said index may for instance be required by a receiver of said transmit signal to be able to perform an inverse mapping operation.

According to a further embodiment of the method for determining a mapping for a sequence of information-carrying values according to the present invention, said information-carrying values are data bits, and said transformation comprises mapping said data bits to modulation symbols, and inverse Fourier transforming said modulation symbols. Said representations then are bit-level representations of said sequence of information-carrying values.

According to a further embodiment of the method for determining a mapping for a sequence of information-carrying values according to the present invention, said information-carrying values are modulation symbols, and said transformation comprises inverse Fourier transforming said modulation symbols. Said representations then are symbol-level representations of said sequence of information-carrying values.

According to a further embodiment of the method for determining a mapping for a sequence of information-carrying values according to the present invention, said inverse Fourier transforming comprises oversampling with any oversampling rate.

According to a further embodiment of the method for determining a mapping for a sequence of information-carrying values according to the present invention, said parameter calculated in each stage is a Peak-To-Average Power Ratio PAPR of said transformation of said representation determined in said stage.

According to a further embodiment of the method for determining a mapping for a sequence of information-carrying values according to the present invention, said extreme value is a minimum value of said parameter.

According to a further embodiment of the method for determining a mapping for a sequence of information-carrying values according to the present invention, said condition said value of said parameter has to fulfil with respect to said pre-defined threshold value is that said value of said parameter is smaller than said pre-defined threshold value.

According to a further embodiment of the method for determining a mapping for a sequence of information-carrying values according to the present invention, said step of determining for which stage of said K stages an extreme value of said parameter is calculated comprises determining, in each stage, if a value of said parameter calculated in said stage is smaller than a best mapping parameter that contains the minimum value of parameters that have been calculated in all preceding stages, and, if this is the case, updating said best mapping parameter with said value of said parameter calculated in said stage, updating a best mapping stage index with an index of said stage and updating a best mapping signal with said transformation of said representation determined in said stage. Then after all stages have been processed, said best mapping stage index contains the index of that stage for which the smallest parameter was calculated, and said best mapping signal contains the transformation of the representation of that stage for which the smallest parameter was calculated. Said best mapping stage index and said best mapping signal then may be output for further processing.

According to a further embodiment of the method for determining a mapping for a sequence of information-carrying values according to the present invention, said mapping operation is a scrambling operation. Scrambling may for instance be performed by means of a linear shift feedback register.

According to a further embodiment of the method for determining a mapping for a sequence of information-carrying values according to the present invention, said mapping operation is a phase rotation operation. This may for instance be accomplished by changing the phase of each value in a representation of a stage in a different manner.

According to a further embodiment of the method for determining a mapping for a sequence of information-carrying values according to the present invention, said mapping operation is an interleaving operation. Said interleaving operation may for instance be a permutation operation performed on the values of said sequence of information-carrying symbols, as for instance a periodic-block interleaving, wherein said sequence is written into a matrix column by column and is then read out row by row.

According to a further embodiment of the method for determining a mapping for a sequence of information-carrying values according to the present invention, said mapping operation is an interleaving operation, and said interleaving operation has a period that is larger than said pre-defined number of stages minus one. Said period of said interleaving operation may be defined as the number of times said interleaving operation has to be performed on a sequence of information-carrying values until said sequence of information-carrying symbols is obtained again. As in said. K stages, said interleaving operation is performed K−1 times on said sequence of information-carrying values, it is advantageous that said period of said interleaving operation is larger than K−1, so that all of said K representations are different.

According to a further embodiment of the method for determining a mapping for a sequence of information-carrying values according to the present invention, said interleaving operation is performed by an interleaver that is already at least partially involved in the generation of said sequence of information-carrying values. Said interleaver may for instance by a channel interleaver that performs interleaving on encoded bits at the output of a channel encoder to increase the resistance of said interleaved encoded bits against burst errors on a transmission channel. Said interleaver then is re-used to perform interleaving on said interleaved encoded bits in order to create different representations of said interleaved encoded bits. The re-use of said interleaver thus allows to perform SLM without requiring an additional interleaver at all.

According to a further embodiment of the method of the present invention, said method is performed by a terminal in a wireless communication system that is based on multi-carrier modulation.

It is further proposed a computer program with instructions operable to cause a processor to perform the above-described method steps.

It is further proposed a computer program product comprising a computer program with instructions operable to cause a processor to perform the above-described method steps.

It is further proposed a device for determining a mapping for a sequence of information-carrying values, comprising means arranged for determining K representations of a sequence of information-carrying values in K successive stages, respectively, wherein in a first stage, a first representation of said K representations is determined to be equal to said sequence of information-carrying values, wherein in subsequent stages, each representation is determined by performing a mapping operation on the representation determined in the preceding stage, and wherein said mapping operation is the same for each stage; means arranged for calculating, in each stage, a parameter from a transformation of the representation determined in said stage; and means arranged for determining for which stage of said K stages an extreme value of said parameter is calculated.

According to an embodiment of the device for determining a mapping for a sequence of information-carrying values according to the present invention, said device is a mobile terminal in a wireless communication system or a part thereof.

According to a further embodiment of the device for determining a mapping for a sequence of information-carrying values according to the present invention, said device is a network element in a wireless communication system or a part thereof.

It is further proposed a method for inverse-mapping a mapped sequence of information-carrying values, wherein said mapped sequence of information-carrying values is a last representation of K′ representations of a sequence of information-carrying values, wherein K′ is smaller than or equal to a pre-defined number of stages that is larger than one, wherein said K′ representations are determined in K′ successive stages, respectively, wherein in a first stage, a first representation of said K′ representations is determined to be equal to said sequence of information-carrying values, wherein in subsequent stages, each representation is determined by performing a mapping operation on the representation determined in the preceding stage, and wherein said mapping operation is the same for each stage, said method comprising successively performing K′−1 inverse mapping operations on said mapped sequence of information-carrying values in K′−1 stages, respectively, wherein in a first stage, a first inverse mapping operation is performed on said mapped sequence of information-carrying values, wherein in subsequent stages, an inverse mapping operation is performed on the result obtained by said inverse mapping operation of the preceding stage, wherein said inverse mapping operation is the same for each stage, and wherein the result obtained by said inverse mapping operation in the last stage of said K′−1 stages represents said sequence of information-carrying values.

Said information-carrying values may for instance be data bits, or modulation symbols that are obtained from data bits by bit-to-symbol mapping as for instance prescribed by a phase- and/or amplitude shift keying scheme.

K′ representations of said sequence of information-carrying values are successively determined, wherein each of said representations basically contains the same information as said sequence of information-carrying values. Therein, K′ is smaller than or equal to a pre-defined number of stages which is larger than one. Said first representation of said K′ representations equals said sequence of information-carrying values, whereas the remaining K′−1 representations are obtained by performing the same mapping operation on the representations of the preceding stage. In effect, then the representation in stage K′ is obtained by successively performing said mapping operation K′−1 times on said sequence of information-carrying values. Said representation in stage K′−1 then is considered as said mapped sequence of information-carrying symbols.

According to this method of the present invention, an inverse mapping then is performed on said mapped sequence of information-carrying symbols by K′−1 times applying an inverse mapping operation, which reverses said mapping operation, on said mapped sequence of information-carrying symbols in a successive manner, so that the same inverse mapping operation is performed in each stage and only one inverse mapping operation is required per stage. Correspondingly, only information on one inverse mapping operation has to be maintained in a device that performs this method of the present invention, allowing for a simplified set-up.

It is further proposed a method for inverse-mapping a mapped sequence of information-carrying values, wherein said mapped sequence of information-carrying values is a last representation of K′ representations of a sequence of information-carrying values, wherein K′ is smaller than or equal to a pre-defined number of stages that is larger than one, wherein said K′ representations are determined in K′ successive stages, respectively, wherein in a first stage, a first representation of said K′ representations is determined to be equal to said sequence of information-carrying values, wherein in subsequent stages, each representation is determined by performing a mapping operation on the representation determined in the preceding stage, and wherein said mapping operation is the same for each stage, said method comprising performing an inverse mapping operation on said mapped sequence of information-carrying values, wherein said inverse mapping operation reverses K′−1 of said successive mapping operations at once, and wherein the result obtained by said inverse mapping operation represents said sequence of information-carrying values.

Said mapping operation may for instance be an interleaving operation, which may for instance be performed by writing said information-carrying values of said representation into an empty matrix column by column and reading it row by row. Said inverse mapping operation depends on said number of stages K′ and reverses K′−1 of said successive mapping operations at once, so that no successive inverse mapping has to be performed.

Each of said mapping operations may for instance be described by an N×N permutation matrix P, so that the mapping of each representation (comprising N bits) in one of said stages can be modelled by multiplying said representation with said permutation matrix P. A corresponding inverse mapping matrix that reverses said mapping operation then is given as P⁻¹, and multiplying said mapped representation with said inverse mapping matrix P⁻¹ then yields said representation again. An L-fold application of said mapping operation (represented by said matrix P, respectively) can then be modelled by a matrix that is obtained as P^{L}, and, correspondingly, an inverse mapping matrix is then given as P^{-L} The K′−1 successive mapping operations (each being described by the same permutation matrix P) performed when determining said mapped sequence of information-carrying values thus can be reversed in a single inverse mapping operation, when said single inverse mapping operation is based on the inverse mapping matrix P^{K′-1}.

Therein, for each possible value of K′, a respective inverse mapping operation (for instance, a de-interleaving operation) may be fixedly implemented in said device and correspondingly selected, or said device may be able to flexibly set-up said inverse mapping operation for each value of K′.

An embodiment of the method for inverse-mapping a mapped sequence of information-carrying values according to the present invention further comprises receiving a transformation of said mapped sequence of information-carrying values, and information on the number of said K′ stages, and performing an inverse transformation on said received transformation of said mapped sequence of information-carrying values to obtain said mapped sequence of information-carrying values.

It is further proposed a computer program with instructions operable to cause a processor to perform the above-described method steps.

It is further proposed a computer program product comprising a computer program with instructions operable to cause a processor to perform the above-described method steps.

It is further proposed a device for inverse mapping a mapped sequence of information-carrying values, wherein said mapped sequence of information-carrying values is a last representation of K′ representations of a sequence of information-carrying values, wherein K′ is smaller than or equal to a pre-defined number of stages that is larger than one, wherein said K′ representations are determined in K′ successive stages, respectively, wherein in a first stage, a first representation of said K′ representations is determined to be equal to said sequence of information-carrying values, wherein in subsequent stages, each representation is determined by performing a mapping operation on the representation determined in the preceding stage, and wherein said mapping operation is the same for each stage, said device comprising means arranged for successively performing K′−1 inverse mapping operations on said mapped sequence of information-carrying values in K′−1 stages, respectively, wherein in a first stage, a first inverse mapping operation is performed on said mapped sequence of information-carrying values, wherein in subsequent stages, an inverse mapping operation is performed on the result obtained by said inverse mapping operation of the preceding stage, wherein said mapping operation is the same for each stage, and wherein the result obtained by said inverse mapping operation in the last stage of said K′−1 stages represents said sequence of information-carrying values.

It is further proposed a device for inverse mapping a mapped sequence of information-carrying values, wherein said mapped sequence of information-carrying values is a last representation of K′ representations of a sequence of information-carrying values, wherein K′ is smaller than or equal to a pre-defined number of stages that is larger than one, wherein said K′ representations are determined in K′ successive stages, respectively, wherein in a first stage, a first representation of said K′ representations is determined to be equal to said sequence of information-carrying values, wherein in subsequent stages, each representation is determined by performing a mapping operation on the representation determined in the preceding stage, and wherein said mapping operation is the same for each stage, said device comprising means arranged for performing an inverse mapping operation on said mapped sequence of information-carrying values, wherein said inverse mapping operation reverses K′−1 of said successive mapping operations at once, and wherein the result obtained by said inverse mapping operation represents said sequence of information-carrying values.

According to an embodiment of the device for inverse mapping a mapped sequence of information-carrying values according to the present invention, said device is a mobile terminal in a wireless communication system or a part thereof.

According to an embodiment of the device for inverse mapping a mapped sequence of information-carrying values according to the present invention, said device is a network element in a wireless communication system or a part thereof.

It is further proposed a system for the transfer of information-carrying values, comprising at least one transmitter and one receiver, wherein said transmitter comprises means arranged for determining K representations of a sequence of information-carrying values in K successive stages, respectively, wherein in a first stage, a first representation of said K representations is determined to be equal to said sequence of information-carrying values, wherein in subsequent stages, each representation is determined by performing a mapping operation on the representation determined in the preceding stage, and wherein said mapping operation is the same for each stage; means arranged for calculating, in each stage, a parameter from a transformation of the representation determined in said stage, means arranged for determining for which stage of said K stages an extreme value of said parameter is calculated, and means arranged for transmitting an index K′ of said stage for which said extreme value of said parameter was calculated, and said transformation of the representation determined in said stage; and wherein said receiver comprises means arranged for receiving said transmitted transformation of said representation and said transmitted index K′, means arranged for performing an inverse transformation on said received transformation of said representation to obtain said representation, and means arranged for successively performing K′−1 inverse mapping operations on said obtained representation in K′−1 stages, respectively, wherein in a first stage, a first inverse mapping operation is performed on said obtained representation, wherein in subsequent stages, an inverse mapping operation is performed on the result obtained by said inverse mapping operation of the preceding stage, wherein said inverse mapping operation is the same for each stage, and wherein the result obtained by said inverse mapping operation in the last stage of said K′−1 stages represents said sequence of information-carrying values.

It is further proposed a system for the transfer of information-carrying values, comprising at least one transmitter and one receiver, wherein said transmitter comprises means arranged for determining K representations of a sequence of information-carrying values in K successive stages, respectively, wherein in a first stage, a first representation of said K representations is determined to be equal to said sequence of information-carrying values, wherein in subsequent stages, each representation is determined by performing a mapping operation on the representation determined in the preceding stage, and wherein said mapping operation is the same for each stage; means arranged for calculating, in each stage, a parameter from a transformation of the representation determined in said stage, means arranged for determining for which stage of said K stages an extreme value of said parameter is calculated, and means arranged for transmitting an index K′ of said stage for which said extreme value of said parameter was calculated, and said transformation of the representation determined in said stage; and wherein said receiver comprises means arranged for receiving said transmitted transformation of said representation and said transmitted index K′, means arranged for performing an inverse mapping operation on said mapped sequence of information-carrying values, wherein said inverse mapping operation reverses K′−1 of said successive mapping operations at once, and wherein the result obtained by said inverse mapping operation represents said sequence of information-carrying values.

These and other aspects of the invention will be apparent from and elucidated with reference to the embodiments described hereinafter.

### BRIEF DESCRIPTION OF THE FIGURES

In the figures show:

FIG. 1a: a transmitter-site and receiver-site bit-level Selected Mapping (SLM) instance according to the prior art;

FIG. 1b: a transmitter-site and receiver-site symbol-level Selected Mapping (SLM) instance according to the prior art;

FIG. 2: a system for the transfer of information-carrying values according to a first and second embodiment of the present invention;

FIG. 3: a transmitter-site SLM instance according to the first and second embodiment of the present invention;

FIG. 4: a flowchart of a method for determining a mapping for a sequence of information-carrying values according to the first embodiment of the present invention;

FIG. 5: a flowchart of a method for determining a mapping for a sequence of information-carrying values according to the second embodiment of the present invention;

FIG. 6a: a receiver-site SLM instance according to the first and second embodiment of the present invention; and

FIG. 6b: an alternative receiver-site SLM instance according to the first and second embodiment of the present invention.

### DETAILED DESCRIPTION OF THE INVENTION

The present invention proposes a method for determining a mapping for a sequence of information-carrying values and a corresponding method for inverse-mapping a mapped sequence of information-carrying values to be deployed in a system for the transfer of information-carrying values. In the following detailed description of the invention, embodiments of the present invention will be exemplarily described in the context of a wireless communication system that uses Multi-Carrier Modulation (MCM), where the present invention contributes to reduce the peak powers of transmit signals.

It should be noted that the description and notation in the opening part of this patent specification may be used to support this detailed description.

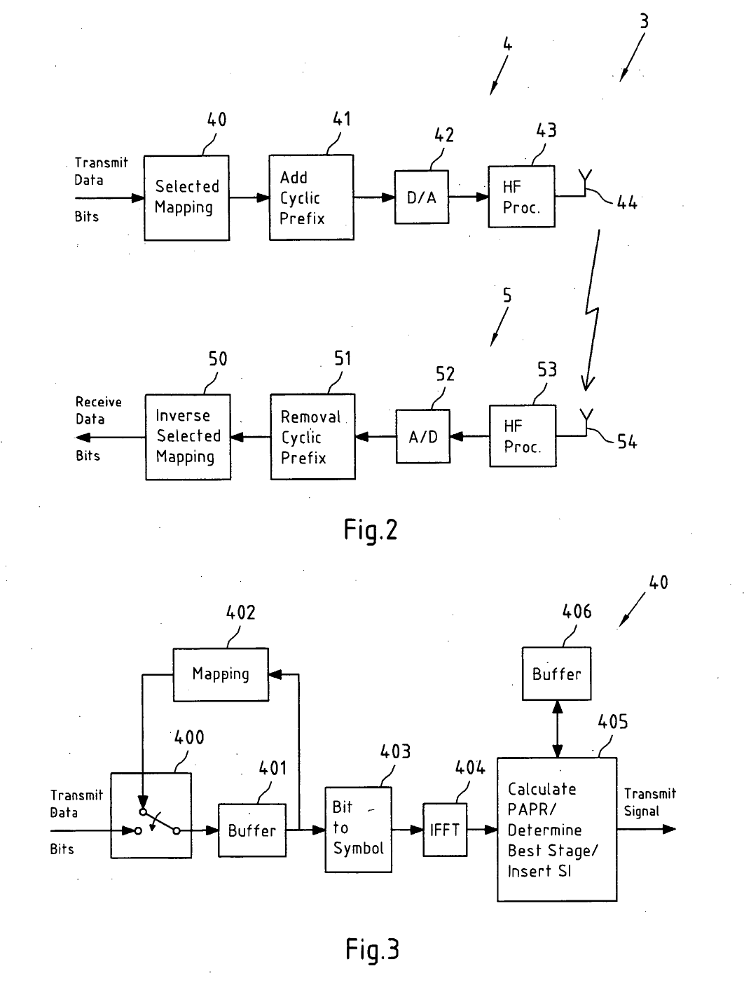

FIG. 2 initially depicts a transmitter 4 and a receiver 5 in a wireless communication system according to a first and second embodiment of the present invention. Said transmitter 4 may for instance be a mobile terminal or a network element in a wireless communication system, and also said receiver 5 then may be a network element or a mobile terminal in a wireless communication system, respectively. In the transmitter 4, a sequence of transmit data bits is fed into a selected mapping instance 40, wherein a transmit signal is selected from a set of transmit signal candidates that are generated in said instance 40. Details on the generation of these transmit signal candidates and the selection of the transmit signal will be described with reference to FIGS. 3-5 below. The transmit signal then is furnished with a cyclic prefix in an instance 41, digital-to-analog converted in an instance 42, amplified and frequency up-converted in a HF processing instance 43 and subsequently transmitted via one or several antennas 44.

The transmit signal then propagates through the wireless transmission channel and is received by one or several antennas 54 of receiver 5.

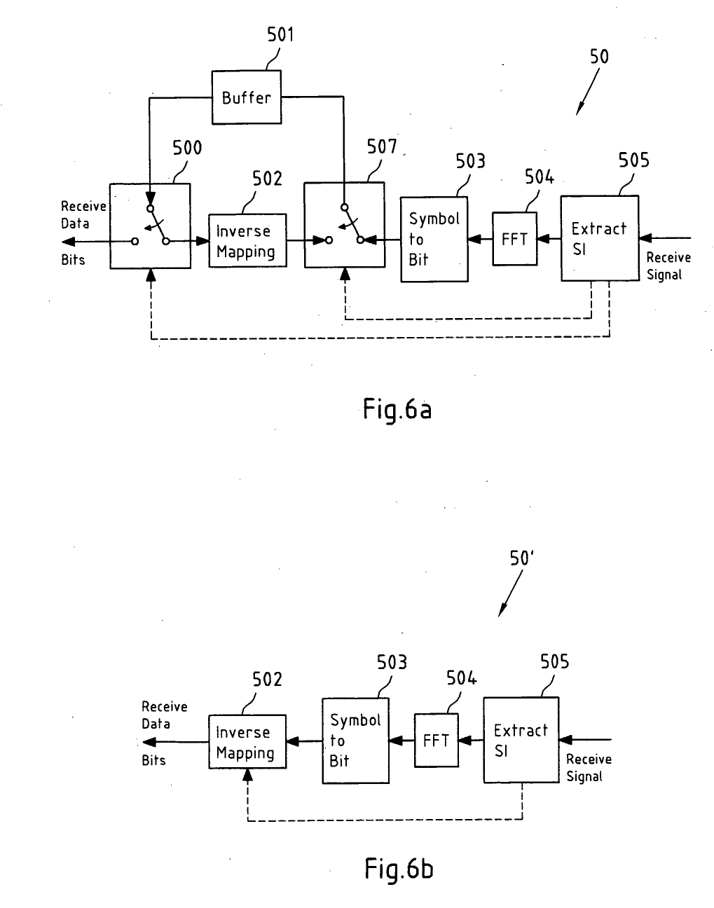

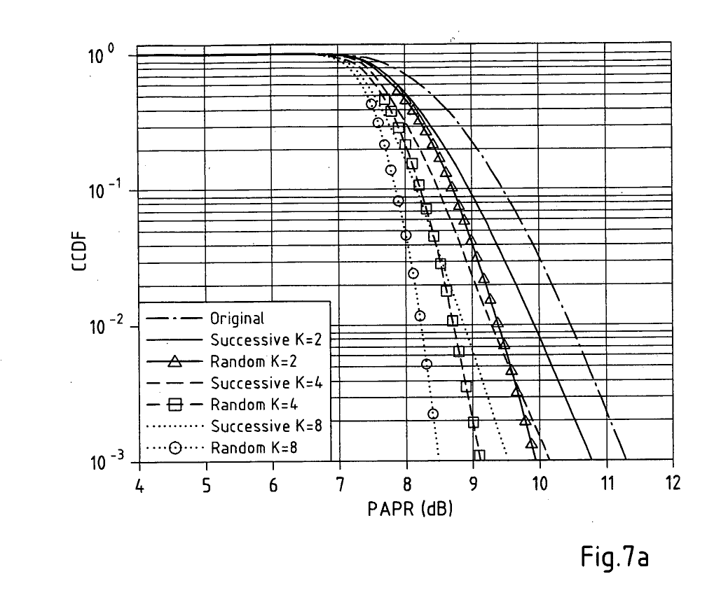

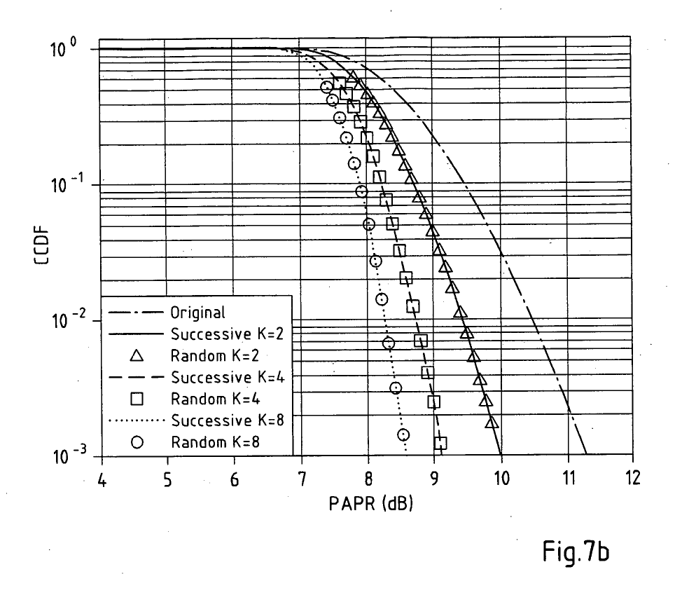

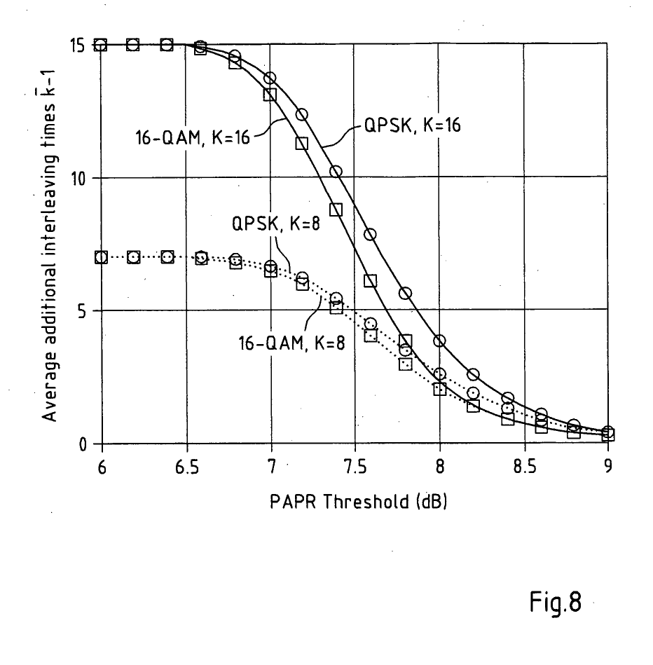

At receiver 5, the receive signal is amplified and frequency down-converted in an instance 53, and digital-to-analog converted in an instance 52. In an instance 51, a cyclic prefix is removed from the receive signal, and the receive signal then is input into an inverse selected mapping instance 50, which outputs a sequence of receive data bits. Details on the functionality of the inverse selected mapping instance 50 will be given with reference to FIGS. 6a and 6b. It is readily understood that said receiver 5 may further comprise functionality to synchronize and equalize the receive signal, which functionality is beyond the scope of the present invention.

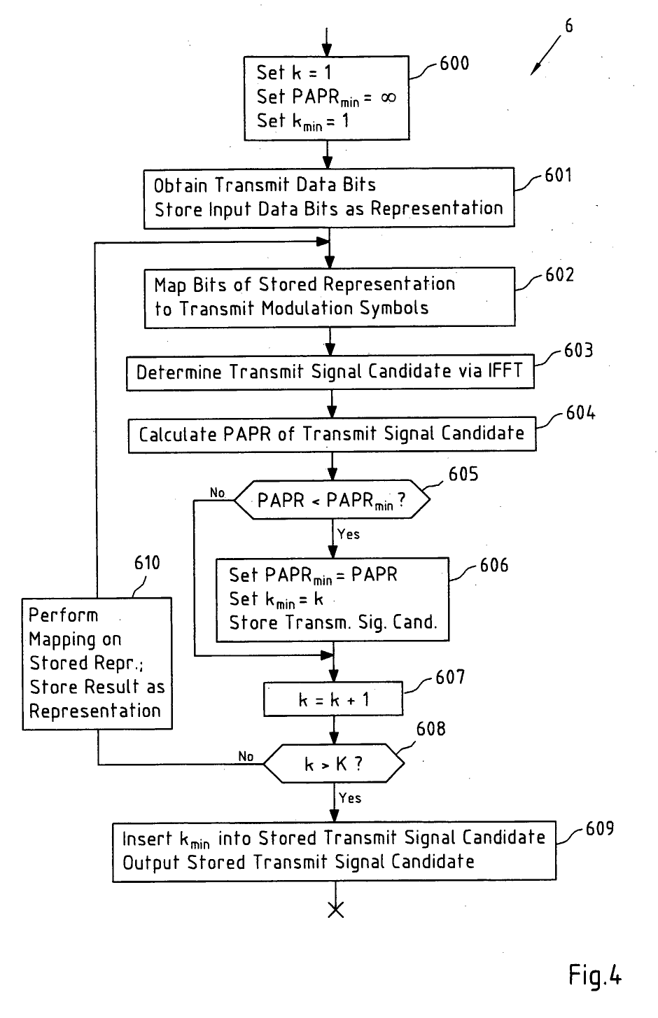

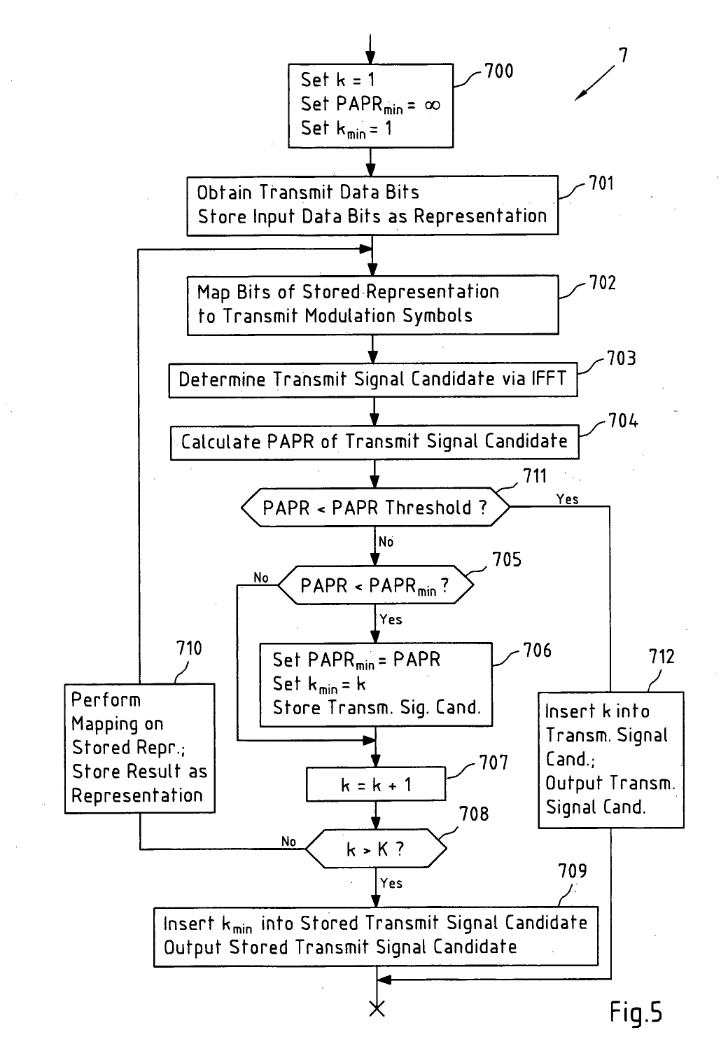

Turning now to FIG. 3, the basic components of a bit-level selected mapping instance 40 according to a first and second embodiment of the present invention are depicted in more detail. The sequence of transmit data bits is input into a switch 400, which can be switched between an input port and a port that is connected to the output of an mapping instance 402 and is operated in accordance to the algorithm that is explained with reference to FIGS. 4 and 5 below. In this exemplary embodiment of the present invention, said mapping instance 402 may for instance be an interleaver, which is capable of performing an interleaving operation on the contents of said buffer 401, wherein said buffer 401 is capable of storing the output of said switch 400. Therein, said interleaving operation performed by said mapping instance 402 may for instance be implemented as periodic block interleaving, for instance based on a matrix with dimensions ┌mN/2┐×2, wherein m indicates the size of the modulation alphabet used for mapping transmit data bits to transmit modulation symbols, and N indicates the size of a block of transmit modulation symbols or the number of sub-carriers of the MCM, and wherein said contents of said buffer 401 are then written column by column into said matrix and are read out row by row.

The output of said buffer 401 is connected to a bit-to-symbol mapping instance 403, in which transmit data bits are mapped to transmit data symbols as prescribed by a phase- and/or amplitude shift keying scheme, such as for instance a Quaternary Phase Shift Keying (QPSK), or a 16 or 64 Quadrature Amplitude Modulation (QAM) scheme. The output of said bit-to-symbol mapping instance 403 is connected to an Inverse Fast Fourier Transformation (IFFT) instance 404, which performs an LN-point inverse Fourier transformation on a block of N transmit modulation symbols, i.e. said transformation comprises an S-fold oversampling. The output of said IFFT instance 404 is connected to an instance 405 that calculates a PAPR of transmit signal candidates received via its input, compares said PAPR to a PAPRₘᵢₙ that is stored in said instance 405, and replaces said PAPRₘᵢₙ with said calculated PAPR and stores said transmit signal candidate in a buffer 406 if said calculated PAPR is smaller than said stored PAPRₘᵢₙ. Said instance 405 is further capable of outputting one of said transmit signal candidates as transmit signal and of inserting Side Information (SI) related to said transmit signal candidate into said transmit signal. Further functionality of said instance 405 with respect to the second embodiment of the present invention will be discussed with reference to FIG. 5 below.

It is readily understood that the bit-level selected mapping instance 40 of FIG. 3 can be straightforwardly transformed into a symbol-level selected mapping instance by moving the bit-to-symbol mapping instance 403 to the input of instance 40, so that the bit-to-symbol mapping instance receives the transmit data bits, maps them into transmit data symbols and then inputs these transmit data symbols into switch 400.

FIG. 4 depicts a flowchart of a first embodiment of the method for determining a mapping for a sequence of transmit data bits according to the present invention. The steps of the flowchart may for instance be performed by the selected mapping instance 40 of FIG. 3. In a first step 600, a stage index k that indicates the present stage k of the successive algorithm is set to 1, a best mapping parameter PAPRₘᵢₙ is initialised to a large value, e.g. infinity, and a best mapping stage index kₘᵢₙ is initialised to 1. In a second step 601, then a sequence of transmit data bits is obtained from an input port of switch 400 (FIG. 3). Said sequence of transmit data bits is then stored in buffer 401 as a first representation of said sequence of transmit data bits.

In a step 602, then the bits contained in said stored representation of said sequence of transmit data bits (which in the first stage k=1 equals the sequence of transmit data bits) are bit-to-symbol mapped to transmit modulation symbols in the bit-to-symbol mapping instance 403 of FIG. 4, and subsequently, in a step 603, an IFFT is performed in IFFT instance 404 on the obtained transmit modulation symbols, yielding a first transmit signal candidate. This first transmit signal candidate corresponds to a transmit signal in a system that does not perform SLM to reduce the PAPR of the transmit signal.

This transmit signal candidate is then fed into instance 405 (cf. FIG. 4), which calculates the PAPR of said first transmit signal candidate in a step 604. In step 605, the calculated PAPR is then compared against said stored best mapping parameter PAPRₘᵢₙ, and if said PAPR is smaller than said PAPRₘᵢₙ, in a step 606 said PAPRₘᵢₙ is updated with said PAPR, said best mapping stage index kₘᵢₙ is updated with said index k of the current stage, and said transmit signal candidate is stored in buffer 406 (cf. FIG. 4). If said PAPR turns out to be larger or equal to said PAPRₘᵢₙ, no action is performed.

In a step 607, said stage index k is increased by one, and it is checked in a step 608 if a pre-defined number of stages K has already been exceeded. If this is not the case, the next stage of the algorithm is entered in step 610 by performing a mapping operation on said stored representation, and updating the stored representation with the result of this mapping operation. This is performed by mapping instance 402 and buffer instance 401, which are connected to each other by turning the switch 400 into the upper position after the first stage. If said mapping instance 402 of FIG. 4 is an interleaver, correspondingly said mapping operation in said step 610 is an interleaving operation. The algorithm then returns to step 602 and proceeds in mapping transmit data bits of said stored representation of said sequence of transmit data bits to transmit modulation symbols, inverse Fourier transforming said transmit modulation symbols to obtain a transmit signal candidate, determining the PAPR and checking whether the best mapping parameter and stage index need to be updated and a new transmit signal candidate needs to be stored.

This loop of steps 602-608 is repeated until said pre-defined number K of stages has been processed, which is checked in step 608. In a step 609, said best mapping stage index kₘᵢₙ then is inserted into said stored transmit signal candidate as SI, for instance appended thereto, and then said stored transmit signal candidate is output as transmit signal.

As can be readily seen from the flowchart 6 of FIG. 4, according to the first embodiment of the present invention, K representations of the sequence of transmit data bits are generated successively in K stages, whereas the first representation equals said sequence of transmit data bits, and the representations in the subsequent stages k=2, . . . , K are obtained by mapping the stored representation of the preceding stage. In each stage, the PAPR of the bit-to-symbol-mapped and inverse Fourier-transformed representation, i.e. the transmit signal candidate, is determined, and the transmit signal candidate with the lowest PAPR and the corresponding stage index k is determined successively. If the K representations of the sequence of transmit data bits are statistically independent, the PAPR of the transmit signal can be significantly reduced.

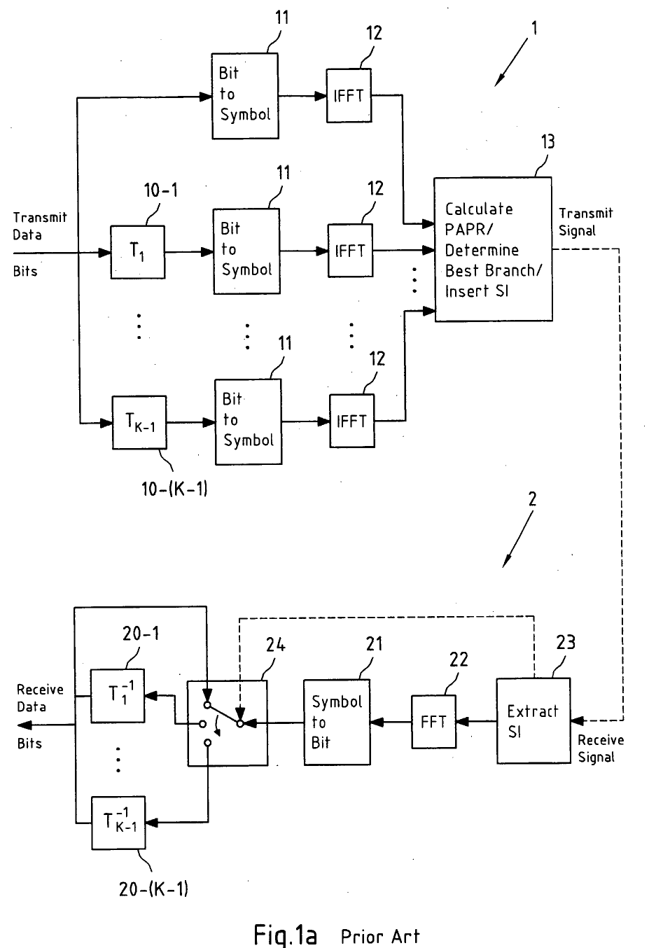

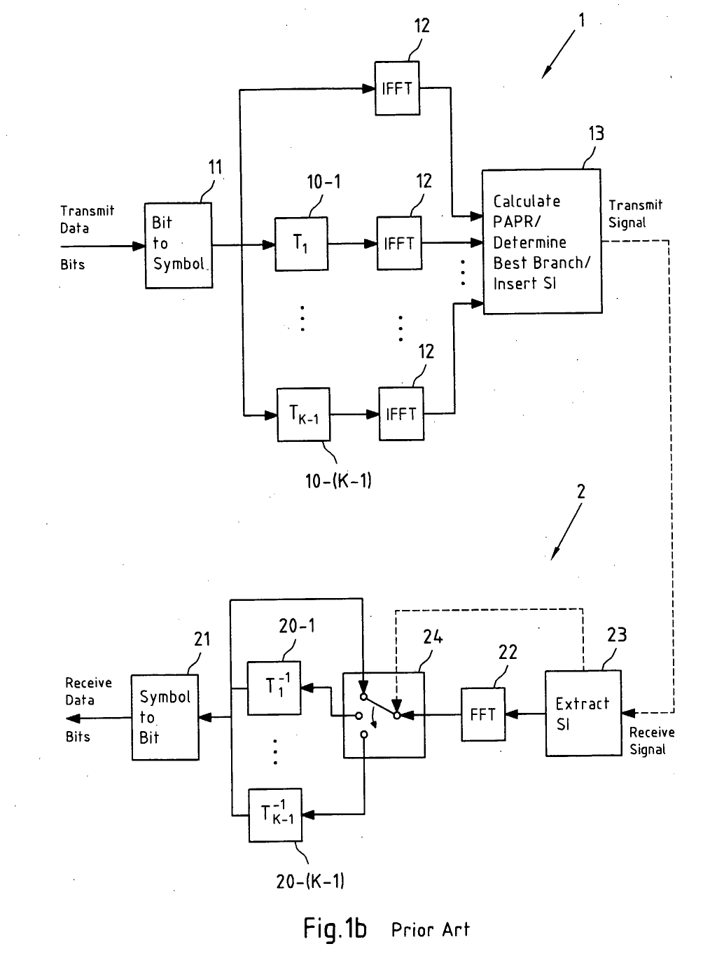

As can be seen from FIG. 3, the method according to this first embodiment of the present invention only requires one mapping instance (e.g. one interleaver) 402, one bit-to-symbol mapping instance 403, one IFFT instance 404 and two buffers 401, 406, in contrast to the prior art method that was described with reference to FIGS. 1a and 1b and that requires K−1 mapping instances 10-1 . . . 10-(K−1), K bit-to-symbol mapping instances 11, K IFFT instances 12 and K buffers to store the transmit signal candidates of each branch before the transmit signal candidate with the lowest PAPR can be determined in instance 13. Thus the present invention allows for a substantial reduction of both the computational complexity and the required memory space while still achieving the same performance as the prior art approach. This is due to the fact that both the prior art approach of FIGS. 1a and 1b and the first embodiment of the present invention according to FIGS. 3 and 4 perform K−1 fold mapping (e.g. interleaving), K fold bit-to-symbol mapping and K fold IFFTs. However, due to the successive generation of the K representations according to the present invention in contrast to the parallel generation of the K representations in prior art, said significant reduction in both computational complexity and required memory space can be achieved.

According to the present invention, a further reduction of the implementation effort can be realized when said mapping instance 402 in FIG. 3 is an interleaver, which then can be replaced by an interleaver that is already contained in the transmitter 3 of FIG. 2. This may for instance be an interleaver that is already deployed in the context of channel encoding of transmit data bits, for instance an interleaver that interleaves the data bits at the output of a channel encoder to obtain the transmit data bits that are subsequently input to said switch 400 of instance 40 (cf. FIGS. 2 and 3). The only restriction imposed on such a re-used interleaver is that the period of said interleaver is larger than K−1, wherein a period of an interleaver is defined as the number of times a sequence of bits has to be interleaved by said interleaver until the original sequence of bits is obtained again. As is readily seen, to obtain a set of K representations of a sequence of transmit data bits that are mutually different, and keeping in mind that the first of said representations equals said sequence of transmit data bits, it is readily clear that the period of the interleaver has to be larger than K−1, because otherwise, said set of K representations would contain equal sequences.

A second embodiment of the present invention uses the same set-up of the transmitter 4 and receiver 5 as depicted in FIGS. 2 and 3, but is slightly modified with respect to the first embodiment in order to allow for a further reduction of the computational complexity. The flowchart 7 of the method for determining a mapping for a sequence of information-carrying values according to this second embodiment of the present invention is depicted in FIG. 5.

The steps 700-709 of the flowchart 7 (cf. FIG. 5) according to the method of the second embodiment of the present invention are the same as the steps 600-609 of the flowchart 6 according to the first embodiment (cf. FIG. 4). In addition, the PAPR that is determined for each transmit signal candidate in step 704 is compared against a pre-defined PAPR threshold, and if the PAPR is found to be smaller than said PAPR threshold, instantly the current stage index k is inserted as SI into the current transmit signal candidate, and then the current transmit signal is output in a step 712. After this step, the method according to the second embodiment terminates even if not all of the K stages have been processed yet.

Thus in contrast to the method of the first embodiment of the present invention, which always successively determines K representations of said sequence of transmit data bits and determines the lowest PAPR of the respective transmit signal candidates that correspond to these K representations, the method according to the second embodiment of the present invention allows to skip the determination of further representations if a representation with achieves a PAPR that is smaller than said pre-defined threshold has already been found.

The selection of said pre-defined threshold allows to trade computational complexity against the probability of a low PAPR. For instance, if a large PAPR threshold is chosen, few different representations will have to be generated in order to find a PAPR that is below said large PAPR threshold, but the reduction of the PAPR will not be as large as in the case where a small PAPR threshold is chosen. However, if said PAPR threshold is small, and if no representation with a corresponding PAPR that is below said PAPR threshold is found during all K stages of said method, still the transmit signal candidate with the lowest PAPR among the K transmit signal candidates will be output by the method in step 709.

The method according to the second embodiment of the present invention thus allows to reduce the computational complexity of the first embodiment by offering a break criterion in step 711 that allows to immediately escape the computation of the K stages of the method if a transmit signal candidate with a particularly low PAPR is found. Furthermore, as the probability that the PAPR exceeds the specification of a power amplifier usually is quite low, using the method according to the second embodiment of the present invention with said PAPR threshold set to said specification of the power amplifier ensures that no clipping of the transmit signal occurs while requiring only the necessary number of stages of the algorithm that are required until a transmit signal candidate the PAPR of which does not exceed the specification of the power amplifier is found. The reduction in computational complexity is particularly noticeable with respect to the IFFT operations that are saved in each stage of the method that does not have to be performed.

FIG. 6a illustrates the basic components of a bit-level inverse selected mapping instance 50 in the receiver 5 according to FIG. 2. Said inverse selected mapping instance is capable of processing transmit signals that were generated in the selected mapping instance 40 (cf. FIG. 2) according to both the first and second embodiment of the present invention. To this end, a method for successive inverse mapping a mapped sequence of transmit data bits according to the present invention is performed in said inverse selected mapping instance 50.

In inverse selected mapping instance 50, at first the SI is extracted from the base-band receive signal in an instance 505. This SI is either the best mapping index kₘᵢₙ (first embodiment) or the stage index k in which the PAPR was found to be below said pre-defined PAPR threshold (second embodiment). The receive signal then is Fourier transformed by means of a Fast Fourier Transformation (FFT) in FFT instance 504, and then the obtained modulation symbols are mapped from symbols to bits in a symbol-to-bit mapping instance 503.

The bits obtained from this symbol-to-bit mapping correspond to a representation of said sequence of transmit data bits that is obtained on the transmitter side by successively mapping said sequence of transmit data bits. To recover said sequence of transmit data bits from the bits output by the symbol-to-bit mapping instance 503 at the receiver, a successive inverse mapping has to be performed, which is implemented by switches 507 and 500, inverse mapping instance 502 and buffer 501, and is controlled according to the SI extracted from the receive signal in instance 505, as indicated by the dashed arrows in FIG. 6. Therein, if, for instance, said mapping operation performed by mapping instance 402 in FIG. 3 is an interleaving operation, said inverse mapping instance 502 in FIG. 6a performs a de-interleaving operation that reverses the effect of said interleaving operation.

If said extracted SI indicates k=1 (or kₘᵢₙ=1), i.e. no mapping was performed on the transmitter site, switch 507 is turned to connect instance 503 and buffer 501, and switch 500 is turned to connect buffer 501 with the output port of instance 50, and the bits as output by the symbol-to-bit mapping instance 503 are directly fed to the output of instance 50 via the buffer 501 without inverse mapping.

If said extracted SI indicates that k (or kₘᵢₙ) is larger than 1, switch 507 is turned to connect instance 503 and buffer 501 for the first stage of the successive inverse mapping process only, and then is turned back again to connect inverse mapping instance 502 and buffer 501. Switch 500 is turned to connect the output of the buffer 501 with the input of the inverse mapping instance 502, except for the last stage of the successive inverse mapping process, in which the switch 500 is turned to connect the output of the buffer 501 with the output of instance 50.

In a first stage of said successive inverse mapping process, the bits as output by the symbol-to-bit mapping instance 503 are then fed into buffer 501. In a second stage, inverse mapping instance 502 performs an inverse mapping operation on the bits stored in the buffer 501, wherein this inverse mapping operation is inverse to the mapping operation in mapping instance 402 of instance 40 in FIG. 3. The output of the inverse mapping instance 502 then is stored in buffer 501 again. If the extracted SI indicates that only two stages are required, switch 500 now can be turned to lead the contents of buffer 501 to the output of instance 50. Otherwise, a further stage of inverse mapping the contents of buffer 501 and storing the result in buffer 501 is performed.

As can be readily seen, similar to the method for determining a mapping for a sequence of information-carrying values, also the method for inverse-mapping a mapped sequence of transmit data bits is performed in successive fashion and is only based on one inverse mapping instance (e.g. a deinterleaver) 502, whereas in prior art, a bank with K−1 inverse mapping instances is required to be implemented. Thus the present invention also contributes to reduce the complexity of the receiver-site SLM instance 50.

In the case that mapping is implemented as interleaving, and inverse mapping is then implemented as deinterleaving, similar to the re-use of a channel interleaver for SLM at the transmitter site, it is also possible to re-use a deinterleaver that is already deployed at the receiver site, for instance a deinterleaver that is used to deinterleave data bits in the context of a channel codec, as SLM inverse mapping instance instead of using an additional inverse mapping instance 502.

FIG. 6b illustrates the basic components of an alternative non-successive bit-level inverse selected mapping instance 50′, which may be used instead of the successive bit-level inverse selected mapping instance 50 in the receiver 5 of FIG. 2.

In FIG. 6b, instances 505, 504 and 503 are the same as their counterparts in FIG. 6a, and have exactly the same functionality. However, in contrast to the successive inverse mapping that is performed by the inverse selected mapping instance 50 of FIG. 6a, the inverse selected mapping instance 50′ of FIG. 6b performs an inverse mapping operation in instance 502′ in one single inverse step, so that no further switches and buffers are required and the time delay caused by successive inverse mapping may be reduced.

Correspondingly, the inverse mapping instance 502′ does not only reverse the effect of one successive mapping operation performed on the transmitter site, but reverses the effect of kₘᵢₙ−1 (first embodiment) or k−1 (second embodiment) successive mapping operations performed on said sequence of transmit data bits at the transmitter site.

Each of said mapping operations can be described by an N×N permutation matrix P, so that, at the transmitter site, the mapping of each representation (comprising N bits) in one of said stages can be modelled by multiplying said representation with said permutation matrix P. A corresponding inverse mapping matrix that reverses said mapping operation then is given as P⁻¹, and multiplying said mapped representation with said inverse mapping matrix P⁻¹ then yields said representation again. An L-fold application of said mapping operation (represented by said matrix P, respectively) can then be modelled by a matrix that is obtained as P^{L}, and, correspondingly, an inverse mapping matrix is then given as p-L The kₘᵢₙ−1 (first embodiment) or k−1 (second embodiment) successive mapping operations (each being described by the same permutation matrix P) performed in said successive mapping of the sequence of transmit data symbols at the transmitter site thus can be reversed at the receiver in a single inverse mapping operation, when said single inverse mapping operation is based on the inverse mapping matrix P^{K′-1}.

In said inverse mapping instance 502′, for each possible value of k and kₘᵢₙ, one respective inverse mapping operation may be fixedly implemented and correspondingly selected based on said SI, or said inverse mapping instance 502′ may be able to flexibly set-up said inverse mapping operation for each possible value of k and kₘᵢₙ.

Again, it is readily understood that also symbol-level inverse mapping can be implemented by the inverse selected mapping instances 50 and 50′ in FIGS. 6a and 6b, respectively, if the symbol-to-bit mapping instance 503 is moved behind the switch 500 in FIG. 6a, and behind the inverse mapping instance 502′ in FIG. 6b. The output symbols of switch 500/inverse mapping instance 502′ are then symbol-to-bit mapped in instance 503 and then are output as receive data bits.

Furthermore, it should be noted that, instead of deploying interleaving as SLM scheme, as exemplarily assumed in some of the embodiments described so far, equally well a successive phase rotation or scrambling scheme may be applied.

In SLM schemes based on phase rotation, K transmit signal candidates representing the same information are obtained by symbol-level processing in the following manner: Define K distinct vectors with length N, all the elements in which are pure phase rotation factors, and multiply the block of transmit modulation symbols with said K vectors carrier-wise, resulting in K different representations of said block of transmit modulation symbols. All the K representations are transformed into respective transmit signal candidates via an IFFT, and then the transmit signal candidate with the lowest PAPR is selected, appended with its rotation vector order and transmitted.

In SLM schemes based on scrambling, a Linear Shift Feedback Register (LSFR) structure is proposed to generate different representations of a sequence of transmit data bits, and in the receiver no explicit side information is then needed to recover the original sequence of transmit data bits from the scrambled sequence of transmit data bits. However, a drawback of this LSRF structure may be its error propagation property.

The successive SLM scheme as proposed by the present invention generates K different transmit signal candidates all representing the same sequence of transmit data bits, and then selects and transmits the transmit signal candidate with the lowest PAPR. Consequently, the probability that this PAPR exceeds given values can be reduced statistically.

In the following part of this detailed description of the invention, with reference to FIGS. 7a, 7b and 8, the PAPR reduction performance that can be achieved by the present invention will be investigated by means of analysis and simulation. Therein, interleaving-based SLM schemes will be exemplarily considered.

The PAPR reduction performance can be expressed in terms of the probability Pr{PAPR>A}, which is denoted as the Complementary Cumulative Distribution Function (CCDF) of the PAPR. Therein, the performance of the best SLM scheme, e.g. random interleaving, may be used as benchmark for the performance analysis of the successive interleaving proposed by the present invention.

Assuming that all the K transmit signal candidates are statistically independent and obey the same CCDF Pr{PAPR>λ}, the CCDF of the transmit signal candidate that is actually selected as transmit signal due to the fact that is has the smallest PAPR is obtained as
Pr{PAPR_{SLM}>λ}=(Pr{PAPR>λ})^{K} (1)
which is the best performance that SLM schemes can achieve.

Therein, the CCDF of the PAPR of the transmit signal candidates can be approximated by
Pr{PAPR>λ}=1−(1−e^{-λ})^{αN} (2)
where α is 1 for Nyquist-rate signal samples and is 2.8 for continuous-time signals.

Plugging equation (2) into equation (1) then yields the benchmark CCDF of the PAPR of the transmit signal candidate (out of the set of K transmit signal candidates) with the lowest PAPR according to the first embodiment of the present invention.

FIGS. 7a and 7b depict simulation results comparing the CCDF of the PAPR for the successive interleaving-based SLM scheme according to the first embodiment of the present invention against the CCFD of the PAPR for a random-interleaving SLM scheme and the CCDF of the PAPR that is achieved without SLM, for Quaternary Phase Shift Keying (QPSK) as bit-to-symbol mapping scheme in FIG. 7a, and for 16 Quadrature Amplitude Modulation (16-QAM) as bit-to-symbol mapping scheme in FIG. 7b. Therein, the CCDFs of the successive and random interleaving-based SLM schemes are parameterized with different numbers of stages K. The simulations are based on a MC system with N=256 sub-carriers and S=4 fold oversampling within the IFFT. The power of the transmit signal is equally distributed over all the sub-carriers. For successive interleaving, a simple periodic interleaver with ┌mN/2┐ rows and 2 columns is used in K stages, wherein m is the modulation alphabet (with m=2 for QPSK, m=4 for 16-QAM and m=6 for 64-QAM), and wherein the period of the interleaver is not less than log₂(mN).

FIG. 7a shows the PAPR CCDF of the bit-level successive interleaving SLM scheme with fixed number of stages K according to the first embodiment of the present invention and the PAPR CCDF of a random SLM scheme for the case of QPSK modulation. Also the PAPR CCDF that can be achieved by the MC system without performing SLM at all is depicted and denoted as “Original”. It can be noticed that, for each number of stages K, the successive SLM scheme is slightly worse than random interleaving, which is used as a benchmark for optimum performance of SLM. However, the reduction of the PAPR that can be achieved by successive interleaving with respect to the MC system without SLM is still significant, and is particularly far less complex in implementation than the random interleaving scheme.

The reduction of the PAPR in dB that can be achieved by the successive interleaving scheme compared to the case that no SLM is performed at all is summarized in the following Table 1 for different numbers of stages K and for QPSK modulation. The values given in Table 1 can be directly derived from FIG. 7a.

TABLE 1
PAPR reduction (dB) for successive interleaving
SLM and QPSK modulation in different CCDF points
(taken from FIG. 7a)

| CCDF | 10⁻³ | 10⁻² | 10⁻¹ |
|---|---|---|---|
| K = 2 | 0.6 | 0.5 | 0.4 |
| K = 4 | 1.2 | 1.1 | 0.9 |
| K = 8 | 1.7 | 1.6 | 1.5 |

FIG. 7b illustrates the PAPR reduction performance of the bit-level successive interleaving based SLM scheme with fixed number of stages K according to the first embodiment of the present invention for 16-QAM modulated MC signals, wherein the random interleaving scheme with the best performance is again used as benchmark for optimum performance. Again, the PAPR CCDF of a MC system without SLM is given for comparison purposes. It can be seen that the successive interleaving scheme according to the first embodiment of the present invention can reach the same performance of PAPR suppression as the optimum random interleaving scheme. The corresponding PAPR reductions in dB of the proposed scheme with different numbers of stages K for 16-QAM are summarized in Table 2.

TABLE 2
PAPR reduction (dB) for successive interleaving
SLM and 16-QAM modulation in different CCDF
points (taken from FIG. 7b)

| CCDF | 0.1% | 1% | 10% |
|---|---|---|---|
| K = 2 | 1.3 | 1.0 | 0.8 |
| K = 4 | 2.2 | 1.7 | 1.1 |
| K = 8 | 2.7 | 2.1 | 1.5 |

Close-to-optimum performance of the successive interleaving scheme and large PAPR reductions compared to the case of an MC system without SLM was also found for the case of 64-QAM modulation.

FIG. 8 finally illustrates the average number of additional interleaving and IFFT operations required on average by the proposed adaptive successive interleaving SLM scheme according to the second embodiment of the present invention for different pre-defined PAPR thresholds (cf. step 711 in the flowchart 7 of FIG. 5). This average number of additional interleaving and IFFT operations is simply the average number of stages k̅ that is required for a given PAPR threshold until a transmit signal candidate with a PAPR that is below said PAPR threshold has been found minus 1. Therein, this number of stages k is limited by the pre-defined maximum number of stages K.

As can be seen from FIG. 8, for both QPSK and 16-QAM modulation, the average number of additional interleaving and IFFT operations k̅−1 decreases dramatically when the pre-defined PAPR threshold (shown on the abscissa) is chosen larger than 7.0 dB. Of course, the decrease is more pronounced for K=16 than for K=8.

Thus by using the adaptive successive interleaving scheme according to the second embodiment of the present invention, the implementation complexity required at the transmitter side can be significantly reduced. The relative complexity reduction that can be achieved by the second embodiment of the present invention with respect to the first embodiment [1−( k̅−1)/(K−1)] is summarized in Table 3.

TABLE 3
Relative complexity reduction of the second
embodiment compared to the first embodiment of the
method of the present invention in percent.

| | |
|---|---|
| QPSK | 16QAM |

PAPR Threshold = 7.5 dB

| | | |
|---|---|---|
| K = 8 | 29.1% | 34.9% |
| K = 16 | 40.3% | 51.3% |

PAPR Threshold = 8 dB

| | | |
|---|---|---|
| K = 8 | 62.7% | 71.1% |
| K = 16 | 75.2% | 84.9% |

As can be seen from Table 3, the relative reduction in complexity is most pronounced for large numbers of stages K and for the modulation scheme with higher orders m (e.g. 16-QAM with m=4).

In summary, the present invention proposes a novel successive SLM scheme with K stages (first embodiment) and a further complexity-reduced successive SLM scheme with a number of stages that is equal to or smaller than a pre-defined number of stages K (second embodiment). A major advantage of the proposed schemes is their simplicity, where only one additional mapping instance (e.g., an interleaver) and inverse mapping instance (e.g., a deinterleaver) are needed at transmit and receiver sites, respectively. Additionally, when mapping is implemented as interleaving, the existing interleaver for channel codec could be straightforwardly utilized by the proposed successive schemes at transmitter and/or receiver site, if the period of the interleaver is larger than the predefined maximum number of stages K.

Consequently, there is then actually no need to have an additional interleaver/deinterleaver in the proposed SLM schemes.

Furthermore, the signalling overhead between transmitter and receiver can be reduced to a negligible amount by the present invention, as only the actual number of stages k needs to be signalled to the receiver.

The simulation results, referring to interleaving-based successive. SLM, prove that the proposed schemes lead to a significant reduction of the PAPR especially in higher order modulation, e.g. 16QAM, and also lead to a significant reduction of the computational costs. By using the successive SLM scheme according to the second embodiment of the present invention, the implementation complexity can be further reduced dramatically.

Considering that the probability that the PAPR exceeds the specification of a power amplifier usually is relative low, according to this second embodiment of the present invention the multistage successive mapping can be terminated immediately, when a PAPR that is below the pre-defined PAPR threshold is found, so that the complexity and the related time delay of SLM can be considerably reduced.

The invention has been described above by means of preferred embodiments. It should be noted that there are alternative ways and variations, which are obvious to a skilled person in the art and can be implemented without deviating from the scope and spirit of the appended claims. In particular, the present invention is not limited to periodic block interleaving, also other SLM schemes such as phase rotation or scrambling can be successively applied. Furthermore, the present invention is not limited to bit-level mapping, equally well symbol-level mapping can be applied in the proposed successive fashion.

1. A method for determining a mapping for a sequence of information-carrying values, comprising:
determining K representations of a sequence of information-carrying values in K successive stages, respectively, wherein in a first stage, a first representation of said K representations is determined to be equal to said sequence of information-carrying values, wherein in subsequent stages, each representation is determined by performing a mapping operation on the representation determined in the preceding stage, and wherein said mapping operation is the same for each stage,
calculating, in each stage, a parameter from a transformation of the representation determined in said stage, and determining for which stage of said K stages an extreme value of said parameter is calculated.

2. The method according to claim 1, wherein said number K equals a pre-defined number of stages.

3. The method according to claim 1, wherein said number K is smaller than or equal to a pre-defined number of stages, wherein said step of determining for which stage an extreme value of said parameter is calculated comprises determining, in each stage, if a value of said parameter calculated in said stage fulfils a condition with respect to a pre-defined threshold value, and wherein, if said condition is fulfilled in a stage, said number K equals the index of said stage in which said condition is first fulfilled, and otherwise equals said pre-defined number of stages.

4. The method according to claim 1, further comprising: outputting an index of said stage for which said extreme value of said parameter was calculated, and said transformation of said representation determined in said stage.

5. The method according to claim 4, wherein said transformation of said representation determined in said stage for which said extreme value of said parameter was calculated represents a transmit signal in a communication system, and wherein information on said index of said stage for which said extreme value of said parameter was calculated is included into said transmit signal prior to transmission.

6. The method according to claim 1, wherein said information-carrying values are data bits, and wherein said transformation comprises: mapping said data bits to modulation symbols, and inverse Fourier transforming said modulation symbols.

7. The method according to claim 1, wherein said information-carrying values are modulation symbols, and wherein said transformation comprises: inverse Fourier transforming said modulation symbols.

8. The method according to claim 6, wherein said inverse Fourier transforming comprises oversampling with any oversampling rate.

9. The method according to claim 1, wherein said parameter calculated in each stage is a Peak-To-Average Power Ratio PAPR of said transformation of said representation determined in said stage.

10. The method according to claim 1, wherein said extreme value is a minimum value of said parameter.

11. The method according to claim 10, wherein said condition said value of said parameter has to fulfil with respect to said pre-defined threshold value is that said value of said parameter is smaller than said pre-defined threshold value.

12. The method according to any of the claim 10, wherein said step of determining for which stage of said K stages an extreme value of said parameter is calculated comprises: determining, in each stage, if a value of said parameter calculated in said stage is smaller than a best mapping parameter that contains the minimum value of parameters that have been calculated in all preceding stages, and, if this is the case, updating said best mapping parameter with said value of said parameter calculated in said stage, updating a best mapping stage index with an index of said stage and updating a best mapping signal with said transformation of said representation determined in said stage.

13. The method according to claim 1, wherein said mapping operation is a scrambling operation.

14. The method according to claim 1, wherein said mapping operation is a phase rotation operation.

15. The method according to claim 1, wherein said mapping operation is an interleaving operation.

16. The method according to claim 2, wherein said mapping operation is an interleaving operation, and wherein said interleaving operation has a period that is larger than said pre-defined number of stages minus one.

17. The method according to claim 15, wherein said interleaving operation is performed by an interleaver that is already at least partially involved in the generation of said sequence of information-carrying values.

18. The method according to claim 1, wherein said method is performed by a terminal in a wireless communication system that is based on multi-carrier modulation.

19. A computer program with instructions operable to cause a processor to perform the method steps of claim 1.

20. A computer program product comprising a computer program with instructions operable to cause a processor to perform the method steps of claim 1.

21. A device for determining a mapping for a sequence of information-carrying values, comprising:
means arranged for determining K representations of a sequence of information-carrying values in K successive stages, respectively, wherein in a first stage, a first representation of said K representations is determined to be equal to said sequence of information-carrying values, wherein in subsequent stages, each representation is determined by performing a mapping operation on the representation determined in the preceding stage, and wherein said mapping operation is the same for each stage, means arranged for calculating, in each stage, a parameter from a transformation of the representation determined in said stage, and means arranged for determining for which stage of said K stages an extreme value of said parameter is calculated.

22. The device according to claim 21, wherein said device is a mobile terminal in a wireless communication system or a part thereof.

23. The device according to claim 21, wherein said device is a network element in a wireless communication system or a part thereof.

24. A method for inverse-mapping a mapped sequence of information-carrying values, wherein said mapped sequence of information-carrying values is a last representation of K′ representations of a sequence of information-carrying values, wherein K′ is smaller than or equal to a pre-defined number of stages that is larger than one, wherein said K′ representations are determined in K′successive stages, respectively, wherein in a first stage, a first representation of said K′ representations is determined to be equal to said sequence of information-carrying values, wherein in subsequent stages, each representation is determined by performing a mapping operation on the representation determined in the preceding stage, and wherein said mapping operation is the same for each stage, said method comprising: successively performing K′−1 inverse mapping operations on said mapped sequence of information-carrying values in K′−1 stages, respectively, wherein in a first stage, a first inverse mapping operation is performed on said mapped sequence of information-carrying values, wherein in subsequent stages, an inverse mapping operation is performed on the result obtained by said inverse mapping operation of the preceding stage, wherein said inverse mapping operation is the same for each stage, and wherein the result obtained by said inverse mapping operation in the last stage of said K′−1 stages represents said sequence of information-carrying values.

25. A method for inverse-mapping a mapped sequence of information-carrying values, wherein said mapped sequence of information-carrying values is a last representation of K′ representations of a sequence of information-carrying values, wherein K′ is smaller than or equal to a pre-defined number of stages that is larger than one, wherein said K′ representations are determined in K′ successive stages, respectively, wherein in a first stage, a first representation of said K′ representations is determined to be equal to said sequence of information-carrying values, wherein in subsequent stages, each representation is determined by performing a mapping operation on the representation determined in the preceding stage, and wherein said mapping operation is the same for each stage, said method comprising: performing an inverse mapping operation on said mapped sequence of information-carrying values, wherein said inverse mapping operation reverses K′−1 of said successive mapping operations at once, and wherein the result obtained by said inverse mapping operation represents said sequence of information-carrying values.

26. The method according to claim 24, further comprising:
receiving a transformation of said mapped sequence of information-carrying values, and information on the number of said K′ stages, and performing an inverse transformation on said received transformation of said mapped sequence of information-carrying values to obtain said mapped sequence of information-carrying values.

27. A computer program with instructions operable to cause a processor to perform the method steps of claim 24.

28. A computer program product comprising a computer program with instructions operable to cause a processor to perform the method steps of claim 24.

29. A device for inverse mapping a mapped sequence of information-carrying values, wherein said mapped sequence of information-carrying values is a last representation of K′ representations of a sequence of information-carrying values, wherein K′ is smaller than or equal to a pre-defined number of stages that is larger than one, wherein said K′ representations are determined in K′ successive stages, respectively, wherein in a first stage, a first representation of said K′ representations is determined to be equal to said sequence of information-carrying values, wherein in subsequent stages, each representation is determined by performing a mapping operation on the representation determined in the preceding stage, and wherein said mapping operation is the same for each stage, said device comprising: means arranged for successively performing K′−1 inverse mapping operations on said mapped sequence of information-carrying values in K′−1 stages, respectively, wherein in a first stage, a first inverse mapping operation is performed on said mapped sequence of information-carrying values, wherein in subsequent stages, an inverse mapping operation is performed on the result obtained by said inverse mapping operation of the preceding stage, wherein said mapping operation is the same for each stage, and wherein the result obtained by said inverse mapping operation in the last stage of said K′−1 stages represents said sequence of information-carrying values.

30. A device for inverse mapping a mapped sequence of information-carrying values, wherein said mapped sequence of information-carrying values is a last representation of K′ representations of a sequence of information-carrying values, wherein K′ is smaller than or equal to a pre-defined number of stages that is larger than one, wherein said K′ representations are determined in K′ successive stages, respectively, wherein in a first stage, a first representation of said K′ representations is determined to be equal to said sequence of information-carrying values, wherein in subsequent stages, each representation is determined by performing a mapping operation on the representation determined in the preceding stage, and wherein said mapping operation is the same for each stage, said device comprising:
means arranged for performing an inverse mapping operation on said mapped sequence of information-carrying values, wherein said inverse mapping operation reverses K′−1 of said successive mapping operations at once, and wherein the result obtained by said inverse mapping operation represents said sequence of information-carrying values.

31. The device according to claim 29, wherein said device is a mobile terminal in a wireless communication system or a part thereof.

32. The device according to claim 29, wherein said device is a network element in a wireless communication system or a part thereof.

33. A system for the transfer of information-carrying values, comprising at least one transmitter and one receiver, wherein said transmitter comprises: means arranged for determining K representations of a sequence of information-carrying values in K successive stages, respectively, wherein in a first stage, a first representation of said K representations is determined to be equal to said sequence of information-carrying values, wherein in subsequent stages, each representation is determined by performing a mapping operation on the representation determined in the preceding stage, and wherein said mapping operation is the same for each stage means arranged for calculating, in each stage, a parameter from a transformation of the representation determined in said stage,
means arranged for determining for which stage of said K stages an extreme value of said parameter is calculated, and means arranged for transmitting an index K′ of said stage for which said extreme value of said parameter was calculated, and said transformation of the representation determined in said stage;
and wherein said receiver comprises:
means arranged for receiving said transmitted transformation of said representation and said transmitted index K′, means arranged for performing an inverse transformation on said received transformation of said representation to obtain said representation, and means arranged for successively performing K′−1 inverse mapping operations on said obtained representation in K′−1 stages, respectively, wherein in a first stage, a first inverse mapping operation is performed on said obtained representation, wherein in subsequent stages, an inverse mapping operation is performed on the result obtained by said inverse mapping operation of the preceding stage, wherein said inverse mapping operation is the same for each stage, and wherein the result obtained by said inverse mapping operation in the last stage of said K′−1 stages represents said sequence of information-carrying values.

34. A system for the transfer of information-carrying values, comprising at least one transmitter and one receiver, wherein said transmitter comprises:
means arranged for determining K representations of a sequence of information-carrying values in K successive stages, respectively, wherein in a first stage, a first representation of said K representations is determined to be equal to said sequence of information-carrying values, wherein in subsequent stages, each representation is determined by performing a mapping operation on the representation determined in the preceding stage, and wherein said mapping operation is the same for each stage; means arranged for calculating, in each stage, a parameter from a transformation of the representation determined in said stage, means arranged for determining for which stage of said K stages an extreme value of said parameter is calculated, and means arranged for transmitting an index K′ of said stage for which said extreme value of said parameter was calculated, and said transformation of the representation determined in said stage;
and wherein said receiver comprises: means arranged for receiving said transmitted transformation of said representation and said transmitted index K′, means arranged for performing an inverse transformation on said received transformation of said representation to obtain said representation, and means arranged for performing an inverse mapping operation on said mapped sequence of information-carrying values, wherein said inverse mapping operation reverses K′−1 of said successive
mapping operations at once, and wherein the result obtained by said inverse mapping operation represents said sequence of information-carrying values.
